(19) United States
(12) Patent Application Publication
(10) Pub. No.: US 2017/0009911 A1
(43) Pub. Date: Jan. 12, 2017

(54) RETAINER PANEL HAVING A THREE-DIMENSIONAL STRUCTURAL SURFACE

(71) Applicant: Wischemann Kunststoff GmbH, Ochtrup (DE)

(72) Inventors: Ingo Wischemann, Ochtrup (DE); Stefan Hubert Ossendorf, Ochtrup (DE)

(21) Appl. No.: 15/270,012

(22) Filed: Sep. 20, 2016

Related U.S. Application Data
(63) Continuation of application No. PCT/EP2015/053225, filed on Feb. 16, 2015.

(30) Foreign Application Priority Data
Mar. 20, 2014 (DE) 20 2014 101 286.9

(51) Int. Cl. F16L 3/26; B32B 3/06; B32B 5/02; F24D 3/14; B32B 3/26; B32B 7/14; B32B 7/06; B32B 3/30; B32B 7/04

(52) U.S. Cl. CPC F16L 3/26; B32B 3/30; B32B 3/06; B32B 5/02; B32B 7/045; B32B 3/266; B32B 7/14; B32B 7/06; F24D 3/141; B32B 2307/748; B32B 2597/00

(57) ABSTRACT

A retainer panel having a carrier made of a thermoforming film and a structural surface that is partially directly laminated to the carrier. The thermoforming film is formed to create a three-dimensional relief structure on the carrier. The structural surface is placed on the carrier with an excess of material, to create a wavy contour with peaks and valleys. The valleys are laminated to the carrier and the peaks remain unlaminated. These unlaminated portions of the structural surface are able to deform easily to adapt to the shape of the object that is placed on the retainer panel. The laminated areas of the structural surface also provide a visually recognizable layout grid. The structural surface forms one part of a touch fastener and an object to be placed on the retainer panel carries the complementary part of the touch fastener.

### BACKGROUND INFORMATION

Field of the Invention

The invention relates to the field of panels used for affixing object to it by means of a touch fastener.

Discussion of the Prior Art

Retainer panels are typically used in panel heating systems, for example, in under-floor, wall, or ceiling heating systems. In these systems, heating tubes are placed in a particular layout on the panel that is intended to provide an even distribution of heat and held in place on the panel.

The conventional retainer panel has a base or carrier that determines the overall shape of the retainer panel, rectangular, square, hexagonal, etc. This carrier typically has a thickness ranging from 1 or 2 mm to several centimeters. The carrier also determines mechanical properties of the retainer panel, for example, whether it is soft or hard, deformable or rigid, and whether the topography is essentially smooth or contoured. This topographical surface is also referred to as the top front side, because it is the side to which the objects are affixed. The opposite side of the carrier, i.e., the underside, is placed and/or attached to a substrate.

A structural surface is arranged on the top side of the carrier. This structural surface forms one component of a touch fastener. In this discussion, the term touch fastener refers to a fastener that is readily releasable, such as a touch hook-and-loop fastener, or other types of fasteners in which two surfaces can be brought together to form an attachment, but then pulled apart again without damaging the fasteners. The reason releasable fasteners are used is to allow the layout of the tubes to be corrected. These types of fasteners, whether touch hook-and-loop fastener or other type of releasable fastener are referred to hereinafter as “touch fasteners.” The touch hook-and-loop fastener is typically the type of conventional releasable fastener that is used in the heating industry, although other variations of releasable fasteners are sometimes used. Thus, the structural surface is often constructed as the fleece or loop component of a touch hook-and-loop fastener and receives an object, for example, a heating tube, that carries the hook component, so that the object is fastened to the structural surface merely be pressing it onto the structural surface.

The conventional carrier for a panel heating system is typically made of a thin film, the entire surface of the carrier being adhesively covered with the structural surface, typically a fleece film, i.e., a film that carries the fleece component. The carrier is arranged on a rigid panel of expanded polystyrene (EPS), so that the conventional retainer panel is a composite of three layers: the EPS panel, the carrier film, and the structural surface. The heating tubes are held in place on the structural surface and the EPS panel serves to provide thermal insulation against the substrate on which the retainer panel is placed.

With the conventional touch hook-and-loop type fastener, the fleece component is typically less expensive to manufacture than the hook component. For this reason, the structural surface on retainer panels that are used in an under-floor panel heating system contain the fleece component, because these types of systems cover a large area and, in an effort to keep the costs down, the relatively large surface area of the structural surface is provided as the fleece component. The comparatively more expensive hook component is provided on the tube and, indeed, is typically not provided as a complete sheath around the tube, but rather, as a band or tape that is wrapped as a spiral around the tube, so that only a substantially smaller surface area has to be covered with this second, more expensive component of the fastener. This is an example of a typical application. Other applications or economic considerations may make it feasible to provide the hook component on the structural surface and the loop component on the object to be fastened to it.

Retainer panels are also used the construction industry. For example, nub panels are known, on which heating tubes for various air-conditioning or heating systems are placed on a panel that has nubs, whereby the nubs exert a clamping force on the tubes, thereby holding them in place on the panel. Typically a nubbed film is used to create a relatively thin nubbed panel. The film is placed on a thicker panel of insulation material and held in place by means of a touch hook-and-loop fastener.

It is also known to use a flat retainer panel to layout heating tubes for an underfloor heating system. This panel does not have contours or nubs, i.e., is flat, and the heating tubes are held in place on the flat panel by means of a touch hook-and-loop fastener.

Both of these types of retainer panels that are used in the construction industry use a fleece film that is laid out flat on the respective carrier.

What is needed, therefore, is a retainer panel that provides a secure hold on an object placed on it, using a touch hook-and-loop fastener. What is further needed, is such a panel that provides a visually recognizable layout grid, without requiring a grid to be printed on the panel. What is yet further needed, is such a retainer panel that is cost-effective to produce.

### BRIEF SUMMARY OF THE INVENTION

It is an object of the invention to improve a conventional retainer panel in a way that improves a reliable fixing of the object on the retainer panel and also supports the most economic manufacture of the retainer panel.

The retainer panel according to the invention has base or carrier, on top of which a structural surface is placed. Incorporated into this structural surface is one component of a two-component touch fastener. For example, if the touch fastener is a touch hook-and-loop fastener, the structural surface carries the fleece component. In the retainer panel according to the invention, the structural surface is affixed to the carrier with an excess of material, this excess material creating a wavy surface. The material of the structural surface has an inherent microscopic roughness because it is a fleece fabric and has many loops on it. The fabric used for the structural surface may be a knitted fabric that contains many loops and may present a flat surface when it is laid out flat, for example, is placed on a flat surface, and/or is pulled tight. The same knitted fabric, when an excess amount is placed on the carrier, creates a ruffled, crimped, wavy, or pleated surface, i.e., a macroscopic relief structure that has a three-dimensional contour created by a crimped, wrinkled, wavy, or pleated surface. Hereinafter, the term “wavy” is used as representative for all macroscopic relief structures of the structural surface, i.e., even then, when the relief structure of the structural surface does not have a regular arrangement or pattern of waves, but rather, has irregularly course of crimps or wrinkles or sharp pleats or other types of protrusions. This wavy construction of the structural surface ensures a secure hold on the object to be held on the retainer panel, even when one of the two surfaces that comprise the touch hook-and-loop fastener has a difficult geometry, such as, for example, an object with a round circumference.

Because of the macroscopic relief structure of the structural surface, the carrier may be kept relatively flat, yet the retainer panel according to the invention still provide the desired holding force on the object placed on it. For example, the carrier may be a flat, undeformed panel or film. A thermoforming film, however, having only a slightly defined three-dimensional structure that is relatively flat may also be used to make the carrier. Nevertheless, even with this flat construction of the carrier, it is still possible to achieve a sufficiently large contact area between the object and the structural surface, even for objects, which, due to their geometry, actually have only a relatively small contact surface for making contact on the retainer pane. A pipe or tube, for example, that only has a line contact on a completely flat surface has a geometry that is normally problematic for a touch fastener, but is able be securely held on the retainer panel according to the invention. This is because the excess material of the structural surface encompasses a greater portion of the circumference of the tube that is pressed onto the retainer panel than is the case when the structural surface is a flat surface that does not have a macroscopic roughness or macroscopic relief structure.

Hereinafter the attachment of a tube to the retainer panel is frequently mentioned, whereby this is an example of its use, such as occurs, for example, with the installation of panel temperature control systems or when supply lines in the form of cables or pipes are to be temporarily laid out at a construction site. The retainer panel according to the invention is not, however, limited to this type of use. It is understood, that the retainer panel according to the invention may also be used to temporarily affix other objects, for example, panels or tiles to a wall, or wall elements on a support frame, something that is advantageous, for example, in setting up trade shows or exhibition rooms.

The entire surface of the material of the structural surface that faces the carrier may be attached to the carrier, for example, by providing an adhesive layer between the carrier and the structural surface and placing the entire surface of the structural surface that faces the carrier on the adhesive. For example, the carrier may be coated with an adhesive and then the structural surface pressed into the adhesive. It may, however, be advantageous, if only lower areas of the macroscopic relief structure of the structural surface are affixed to the carrier. For example, the wavy contour has peaks and valleys and only the valleys are affixed to the carrier, leaving the peaks loose, i.e., unattached to the carrier. This loose material of the structural surface is, thus, freely movable, and therefore able to easily deform to some extent and, because of that, is readily adaptable to the outer shape of an object that is placed on the retainer panel. In the case of a tube, then the loose material is able to conform to a portion of the circumference of the tube, thereby increasing the area of contact between tube and structural surface.

Various process steps can be implemented, either individually or in combination, to achieve the macroscopic relief structure of the structural surface: For example, the structural surface, which is delivered as a semi-finished product, such as, for example, a textile loop product, may be pressed onto the carrier by means of a pressing tool, for example, a roller. An adhesive may be used to create a bond between the structural surface and the carrier.

Advantageously, the carrier may be plastically deformable state, when the structural surface is applied, allowing the structural surface to be partially pressed into the surface of the carrier and thereby creating a firm bond between the structural surface and the carrier, once the carrier has hardened into its final state. This process is referred to as direct lamination and it has the advantage that the bond is created without the use of additional material, such as an adhesive.

The carrier is in a plastically deformable state while it is being produced and so, has the necessary plastic deformability for the lamination process during the production process. Thus, the carrier does not have to be first produced separately and then, possibly hours or days later, the structural surface directly laminated to it. Rather, the structural surface is laminated to the carrier before the carrier has hardened or set to its finished state. This direct lamination process eliminates certain material handling steps, for example, intermediate storage of the carrier, and also eliminates the energy that would otherwise be necessary to make an already finished carrier plastically deformable again, at least on its front side, for a subsequent direct lamination of the structural surface to the carrier.

If a carrier made of a thermoplastic plastic material is used, an already finished carrier product can be used for the lamination process by heating the carrier.

As previously mentioned, the front side of the retainer panel, i.e., the structural surface, is one of the two surfaces that form the touch fastener. In the direct lamination process, a portion of the material of the structural surface is pressed into the material of the carrier, and because of this, does not contribute or contributes only in a limited way to the creation of the touch fastener. The loose portions of the material of the structural surface, i.e., those that are not bonded to the carrier are sufficient, however, do provide adequate contact surface to achieve a reliable touch fastener.

The structural surface may be produced as a two-dimensional textile, but with different thread tensions applied to the threads during the production process. After the textile has been produced and the external tension removed, then the threads previously under tension now shorten in length, creating a crimped or wavy three-dimensional relief structure. The structural surface that the three-dimensional relief structure is to have later is a function of what tensions are applied to which threads during the production of the two-dimensional textile. In this way, the textile may be produced to be more or less wavy, or to have a more or less regular pattern of waves.

Although it is possible that the retainer panel according to the invention have a flat construction, providing a three-dimensional relief structure on the upper side of the retainer panel that receives the object, i.e., a tube, to be attached to it achieves substantially greater holding forces on the object. For the sake of simplicity, the discussion will refer to a tube as the object to be held on the retainer panel, although it is understood, that the object may be something different. The underlying concept of the relief structure on the retainer panel is that relief structure has raised areas and relief areas and that the tube is placed in a relief area, so that it makes contact against the sides of the raised areas, thereby resulting in a relatively large contact area between retainer panel and tube.

In a first embodiment, the relief structure is provided on the carrier. Parallel ribs form the raised areas of the relief structure. A channel is formed between each of two such parallel ribs that is able to accommodate at least a portion of the circumference of the but. The contact area between the tube and the retainer panel is, thus, significantly larger than if the tube were to be placed on a flat retainer panel. As a result, there is a larger contact area between the hook component on the tube and the fleece component on the structural surface, with the end effect that greater forces are needed to separate the tube from the retainer panel.

If only some areas of the structural surface are attached to the carrier, namely, there where the carrier has raised areas, then the structural surface is able to deform easily and make contact with the tube that is pressed onto the retainer panel. For example, the structural surface may be pressed onto the carrier with a roller during the lamination process and, depending on the size of the roller and the relief structure of the carrier, the structural surface then comes into contact with the carrier only at the raised areas of the carrier. As a result, there are areas of the structural surface that are laminated to carrier and other areas in which the structural surface extends a slight distance across relief areas of the carrier or hangs down slightly, so that the structural surface of the retainer panel is relatively freely movable at these relief areas and is able to adapt to the circumference of the tube that is pressed onto the retainer panel.

The same advantage may also be achieved with another relief structure of the carrier, for example, a relief structure that has raised areas in the form of nubs or bumps, whereby these nubs may all have the same sized or they may be differently sized. The nubs may be individual dot-like nubs or they may be in the shape of a cross of an X. Any two adjacent nubs form a trough between them that functions similarly to the previously mentioned channels that are formed by two parallel ribs, in that they can receive a portion of the circumference of a tube. The discussion below often refers to ribs and channels, but these terms are merely representative or various shapes or forms of raised areas on the retainer panel that define relief areas that function as troughs or channels.

Advantageously, a three-dimensionally shaped thermoforming film may be used to form the carrier. This results in a cost-effective production of the retainer panel. The thermoforming film receives its relief structure by means of a thermoforming process and because of this, it has a temperature that makes it possible to laminate the structural surface onto it with relative small energy input and without the use of additional materials, such as, for example, adhesive. Due to the relief structure of the three-dimensionally formed thermoforming film, the surface of the resulting retainer panel maintains a relief structure with relief areas and raised areas after the structural surface has been applied to the carrier.

A grout compound may be applied after the tube is placed on the retainer panel. The tubes are then finally fixed in their desired location after the grout compound has hardened. A plurality of through-holes may be provided on the retainer panel, so that the grout compound can bond the retainer panel as well as the tube to the substrate on which the retainer panel is placed.

It is desirable to keep the overall height of the retainer panel as low as possible and the construction of the retainer panel according to the invention means that the height may be reduced to at most 10 mm. Thus, the retainer panel is relatively flat or thin, but, because of the relief structure of the carrier and/or the waviness of the structural surface, still suitable to provide a hold on tubes of different diameters. The flat construction of the retainer panel also simplifies the production of the carrier, because the thermoforming film only has to be stretched slightly, and this contributes to a cost-effective production.

Advantageously, it is particularly possible that the retainer panel according to the invention have a height of at most 3 mm. Practical tests have shown that a trough or channel having a depth of 1 to 2 mm between two raised areas, for example, ribs, provides a significantly greater contact surface between the two interacting components of the touch hook-and-loop fastener, one being on the tube and the other on the retainer panel. Aside from the economic advantages in producing the retainer panel, transportation is also significantly more economical, because a flatter or thinner retainer panel significantly reduces the transport volume that is necessary for a surface area to be covered with a layout of the panels.

The channels formed by ribs may be arranged in a quadratic grid having straight, intersecting channels, so that heating tubes may be laid out lengthwise and crosswise on the panel. The channels are ideally spaced evenly apart, and the distance of one channel to an adjacent one is preferably greater than the distance between two raised areas that form the boundaries of a channel, for example, between the two ribs that form a channel. Layout grids may be dimensioned for specific purposes. Just by way of example, the layout grid may be designed so that two ribs that form a channel are 8 to 20 mm apart and two parallel channels formed by ribs are between 4 and 10 cm apart.

The discussion above described channels bounded on both sides by ribs. In an alternative embodiment of the retainer panel according to the invention, the raised profiles may be used to create the relief structure, i.e., to create relief or deeper areas on the surface in a way that creates continuous, intersecting deeper areas or troughs between the raised profiles and that also allow the heating tubes to be laid out in lengthwise and crosswise directions. It is also possible to provide additional raised profiles on the areas between the intersecting channels formed by ribs. These raised profiles may be formed similarly to the other raised areas or differently.

Heating tubes are frequently laid out in a serpentine path on retainer panels and these raised profiles serve to guide the heating tubes along a curved path. The section of the heating tube that is curved can bump up against contours formed by these raised profiles. Let's assume that a heating tube is to be laid out to curve so as to achieve a 90-degree change in direction. The channels formed by ribs provide a straight-lined grid that does not accommodate a curved run of the heating tube. The curved section of the heating tube, however, makes contact against one or more raised profiles. The heating tube is in contact with the raised profiles not at the bottom of the tube, but rather, somewhat higher on the wall of the tube. Depending on the configuration of the raised profiles, the contact between heating tube and raised profile may be on the inside and/or outside curve. The tube is not lying within a channel in this curved section and, without the raised profiles, would normally only have a minimal contact with the retainer panel on this otherwise flat surface. But this contact of the heating tube against a raised profile increases the contact surface area, thereby improving the holding force on the heating tube in this curved section.

As previously mentioned, the layout of a plurality of retainer panels has to be done such, that the channels or deeper areas of adjacent panels are aligned, so that the heating tube may be smoothly guided from one retainer panel to another. To this end, the retainer panels are constructed so that, when properly installed, they cannot slip relative each other. To achieve this, an overlap strip is provided on at least one edge of the retainer panel according to the invention. This overlap strip extends out from the underside of the retainer panel, i.e., extends out to the side, beyond the edge of the retainer panel, and may be adhesively affixed with a second retainer panel of the same type.

Providing retainer panels that are self-adhesive is a way to simplify the installation of a plurality of retainer panels. This makes it possible to adhesively affix two retainer panels of the same type to each other in the overlap area. For example, the overlap strip may be adhesive, so that a second retainer panel may be placed on the adhesive overlap strip. Alternatively, the underside of the retainer panel may be adhesive. This makes it possible to adhesively affix the retainer panel in proper alignment next to an adjacent retainer panel. It may also be advantageous, that, even with an overlap strip, the underside of the retainer panel is adhesive in an area beyond the area of the overlap strip, so that the retainer panel, when it is placed on a substrate, is adhesively fixed in position. Adhesively joining retainer panels in this way significantly simplifies the subsequent laying of the heating tubes, because no additional elements are required, such as, for example, rigid carrier panels, etc., on which the retainer panel is affixed. As a result, the structural height for the panel heating system may be kept as low as possible. Also, adhesively installing these retainer panels simplifies a possible de-installation of the panel heating system later, for example, when renovating rooms that were not originally intended to have panel heating systems installed.

Knitted fabric, loops, or mushroom-shaped fastener elements may be used to form the structural surface of the retainer panel that is referred to as the fleece or velour component of a touch hook-and-loop fastener. For example, the structural surface may be a fleece textile that has a plurality of loops. Using the fleece component to form the structural surface has several advantages. It enables a very flat construct of the retainer panel, it is a cost-effective way to produce the retainer panel, and it also provides sufficiently strong hold forces to securely fasten the tubes to the panel, whereby the tubes form the second component of a fastener, i.e., the hook component of the touch hook-and-loop fastener.

As mentioned above, the structural surface may be laminated directly to the carrier. This is advantageous, because a fleece film is not required as an intermediate product that is additionally affixed to a carrier, in order to create the retaining panel. Also, direct lamination eliminates an intermediate adhesive layer, which helps in maintaining a very flat retainer panel. Pressing the structural surface partially into the carrier also contributes to a flatter retainer panel.

In panel heating systems, it is important that a certain number of tube sections of the panel heating system be laid out with the most even spacing possible, in order to ensure the desired thermal performance and even distribution of heat. For this reason, it is typical in the field to print a layout grid in the form of lines or dots or other graphic elements on the retainer panel. This layout grid simplifies the proper installation of the tubes.

The retainer panel according to the invention also enables a visual recognition of the layout grid without requiring that a grid be printed on the panel. As described above, the complete surface of the structural surface is not bonded, either adhesively or by direct lamination, to the carrier. Instead, only certain areas of the structural surface, i.e., the valleys of the wavy material, are bonded to the carrier. The bonded areas look different than the non-bonded areas. This process of bonding only certain portions of the structural surface to the carrier creates a pattern that is visually recognizable by the installer.

The bonded surface sections may advantageously be arranged in the desired layout grid. For example, the previously mentioned profiled roller may have outwardly protruding or raised sections on its circumference. If an adhesive is used to bond the structural surface to the carrier, then the visual recognition of the bonded sections may be enhanced by adding color to the adhesive. If the top side of the carrier itself is not a flat surface, but rather, has a three-dimensional relief structure to it, then the relief structure may be constructed as a type of layout grid, so that even without adhesive, with direct lamination of the structural surface to the carrier, the layout grid is visually recognizable. Creating the layout grid by means of the bonding of certain areas of the structural surface to the carrier provides economic advantages in the production of the retainer panel, because it eliminates material and production steps which would otherwise be required for printing the retainer panel to create a layout grid.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a top plan view of a first embodiment of the retainer panel according to the invention.

FIG. 2 illustrates a second embodiment of the retainer panel, with a portion of the structural surface removed to show the underlying carrier.

FIG. 3 illustrates a third embodiment of the retainer panel, with a portion of the structural surface removed to show the underlying carrier.

FIG. 4 is a vertical cross-sectional cut through a section of the retainer panel according to the invention, showing a carrier with a relief structure and wavy structural surface.

FIG. 5 is a vertical cross-section cut through a section of the retainer panel, showing the wavy structural surface on a flat section of the carrier.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

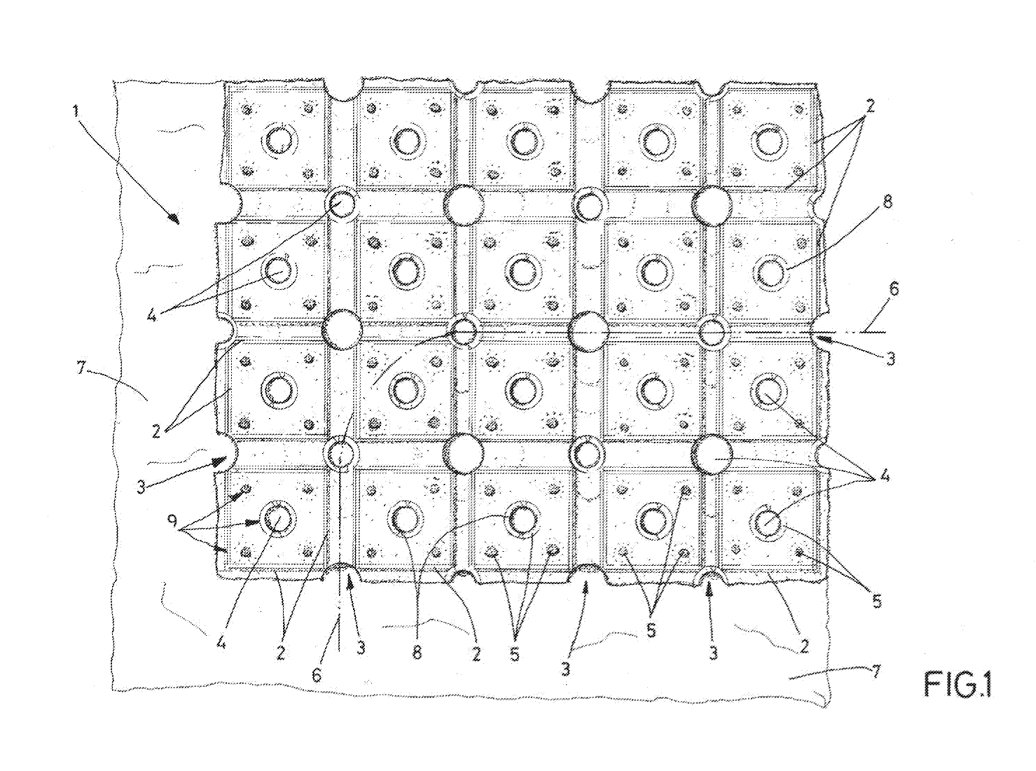

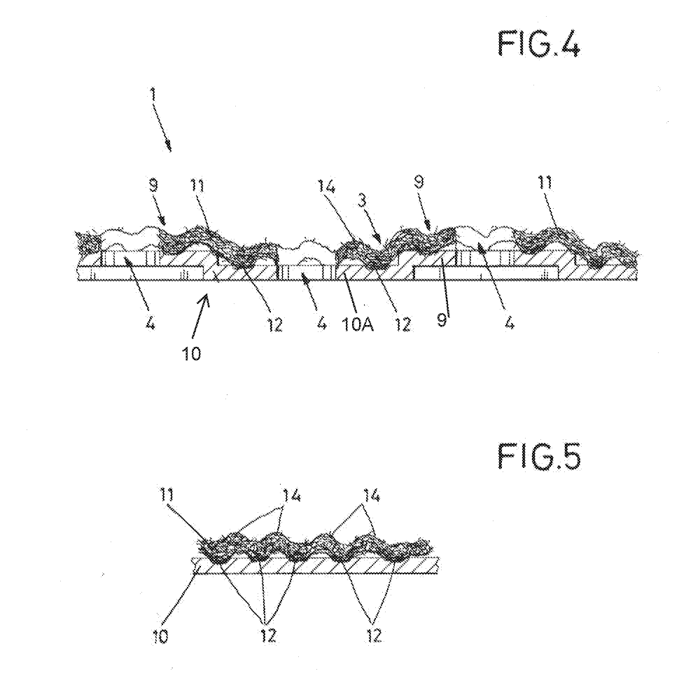

FIGS. 1-3 illustrate three embodiments of a retainer panel 1 according to the invention, which is particularly suited to reliably secure cables or tubes, such as, for example, a heating tube laid out in a serpentine course; FIGS. 4 and 5 illustrate the basic structure of the retainer panel 1, which comprises a base or carrier 10 and a structural surface 11 that is directly laminated to the carrier 10.

The structural surface 11 is an element that serves as a velour, fleece component, or loop component of a touch hook-and-loop fastener. The structural surface 11 completely covers the entire surface of the carrier 10. The carrier 10 is shown in FIG. 5 as a flat element, without a relief structure. According to the invention, either an overall flat carrier 10 may be used or alternatively a carrier 10 with a relief structure. If a relief structure is used, then FIG. 5 is to be interpreted as showing merely a small section the carrier 10 that does not happen to show a three-dimensional contour.

The structural surface 11 of the retainer panel 1 according to the invention has a three-dimensional structure that increases the contact area of the structural surface 11 with the object to be held in place the retainer panel 1 beyond what is possible, if the structural surface 11 were a flat surface. This three-dimensional structure may be produced in several ways, either by created a structural surface 11 that has a three-dimensional or wavy structure or by applying an initially smooth surfaced structural surface 11 to the carrier 10 in a way that creates the desired structure. The structural surface 11 shown in FIGS. 4 and 5 is made of a knitted textile and, due to the texture of the material, has a roughness or contour on the carrier 10 that goes beyond any microscopic roughness, i.e., has a macroscopic roughness or wavy contour. This macroscopic waviness is produced by applying different tensions to the threads during the production process, so that the finished textile product has a three-dimensional, relief-like, crimped or wave-like structure. Such textile structures are also referred to as “crushed,” i.e., wrinkled. The structural surface 11 is, thus, applied to the carrier with an excess of material. A similar effect may be achieved by using a textile product that is initially a smooth, non-wavy material, such as, for example, the mentioned knitted textile, and applying it to the carrier 10 with a roller having a sufficiently defined contour that will result in a wavy surface on the structural surface 11.

The structural surface 11 is directly laminated onto the carrier 10 while the material is warm and has not yet set. The material of the structural surface 10 is actually pressed into the material of the carrier 10 and, as the material of the carrier 10 sets, the two materials become firmly bonded together. The wavy structure of the structural surface 190 has peaks 12 and valleys 14 and these valleys 14 are laminated into the carrier 10. The peaks 14, by contrast, are not only not incorporated into the carrier 10, but actually do not necessarily make contact with the carrier 10. Because of this loose placement of the peaks 14, they remain freely movable and, thus, readily deformable to some extent to accommodate a portion of the circumference of the object to the held on the retainer panel 1.

FIG. 1 illustrates a retainer panel 1 in which the carrier 10 is made of a three-dimensionally contoured thermoforming film. Ribs 2 are formed in the carrier 10, arranged in intersecting parallel layouts, so as to create squares that are evenly spaced apart. Any two parallel adjacent ribs 2 create a channel 3 between them, the channel having a depth of 1 to 2 mm and are dimensioned to accommodate a portion of the circumference of a tube that is to be placed on the retainer panel 1. As shown, the channels 3 are regularly spaced and intersect each other at 90-degree angles.

A central through-hole 4 in the form of a circular hole is provided in the middle of each of the squares formed by the ribs 2. A through-hole 4 may also be provided at the channel intersections. These through-holes 4 may differ in size.

Additional raised areas 9 may also be formed on the carrier 10. These raised areas 9 may have shapes that differ from that of the ribs 3. In the embodiment shown in FIG. 1, the raised areas 9 include raised profiles 5 and 8. Four raised profiles 5 are formed inside the squares that are defined by the four ribs 2 and are spaced a distance around the central through-hole 4. These raised profiles 5 are in the form of dots or nubs. The raised profiles 8 are formed around the central through-bores 4 inside each square.

A tube 1 is representative of an object to be held in place on the retainer panel 1 according to the invention and is very schematically represented in FIG. 1 by a dashed line. A first section of the tube 6 runs in a first section of a first channel 3 that extends in the longitudinal direction of the retaining surface 1 and a second section runs in a second channel 3 that runs in the transverse direction. In the curved section between these first and second sections, the tube 6 runs between the raised areas 5 and 8, so that the hook portion of the touch hook-and-loop fastener, which is provided on the outside of the tube 6 has the greatest possible contact area to the retaining surface 1 not only in the channels 3, but also in the curved section outside of the channels 3. These raised profiles 5 and 8 provide a relief area that is trough-like or channel-like and that is able to accommodate a curved tube 6, i.e., sides of the tube 6 make contact with these raised areas 5 and 8, either on the outside or inside of the curve, thereby achieving a larger contact area between the structural surface 11 and the tube 6 in this curved section than would be the case if the retaining surface 1 were flat in this area. In addition to the relief structure of the carrier 10, the macroscopic relief structure of the structural surface 11 further increases the contact area of tube 6 with the retaining surface 1, so that, overall, the retainer panel 1 according to the invention provides very high holding and pull-off forces, ensuring that the tube is securely held in place on the retaining surface 1.

With continued reference to FIG. 1, an overlap strip 7 is provided on two sides of the retainer panel 1, namely, along one width side and one length side. In this embodiment, a self-adhesive coating is applied to the underside of the retaining surface 1, i.e., to the side of the carrier 10 that faces away from the structural surface 11. This coating may be applied to the complete surface or in a grid pattern made of lines or dots, so that the retaining surface 1 may be affixed to a substrate as well as to an overlap strip 7 of an adjacent retaining surface 1.

Alternatively, the overlap strip 7 may be provided on the upper side of the retaining surface 1. For example, it may be formed by the structural surface 11, i.e., by the textile element that is the fleece component of the touch hook-and-loop fastener. In this case, the structural surface 11 is cut appropriately oversized so that it extends beyond the two sides of the carrier 10, i.e., the thermoforming film, as shown in FIG. 1. The underside of the overlap strip 7 is constructed such, that it can be connected to an adjacent retaining surface 1. To this end, a strip of the hook component of the touch hook-and-loop fastener, for example, is provided on the underside of the overlap strip 7, and the overlap strip 7 be pressed from above and fastened to the structural surface 11 of an adjacent retaining surface 1. Alternatively, the underside of the overlap strip 7 that is placed on top of an adjacent overlap strip 7 may be coated with an adhesive.

It is possible to manufacture the retaining surface 1 in a cost-effective way. The low three-dimensionality that is provided with the thermoformed retaining surface 1 has a positive influence on keeping production costs low. Also, the circular raised profiles 8 that are provided around the central through-holes 4 are created by providing a raised profile having initially a large, circular surface area and then stamping the appropriate circular surface portions from it, in order to create the central through-hole 4 in the center of a square along with its raised profile 8. As has been explained, the structural surface 11, which is the fleece component of the touch hook-and-loop fastener, is laminated onto the carrier 10, i.e., onto the thermoforming film, and this means that the stamping process does not cause a problem, because the laminated fleece material is firmly bonded with the thermoforming film. As a result, a precise stamp line is producible in the stamping process, because the fleece material cannot pull and yield and thereby avoid being stamped.

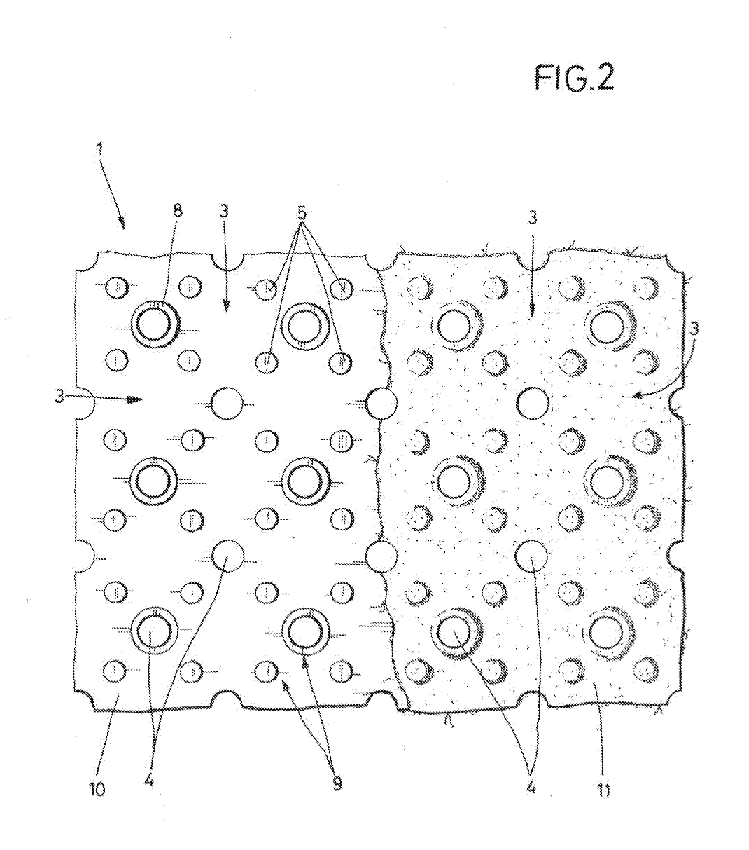

FIG. 2 illustrates an embodiment of the retaining surface 1 according to the invention that essentially corresponds to the embodiment of FIG. 1, except that the carrier 10 does not have the ribs 2. Instead, the raised areas 9 that create the desired relief structure of the retaining surface 1 are created exclusively by the raised profiles 5 and 8. As with the embodiment shown in FIG. 1, four smaller raised profiles 5 are arranged in a quadratic pattern around each central through-hole 4 with its circular raised profile 8. This configuration of five raised profiles 5 and 8 is referred to as a nub group.

In a further differentiation from the embodiment of FIG. 1, the four smaller raised profiles 5 of such a nub group in the embodiment of FIG. 2 may be spaced a greater distance from the central raised profile 8 than is shown in FIG. 1. Also, the quadratic grid pattern in which the individual nub groups are arranged relative each other may be smaller than is shown in the embodiment of FIG. 1. In any case, the result is that troughs or channels 3 run in straight lines and cross each other between the nub groups, the channels 3 having a similar width as the channels 3 shown in the embodiment of FIG. 1 that are defined by the parallel ribs 2.

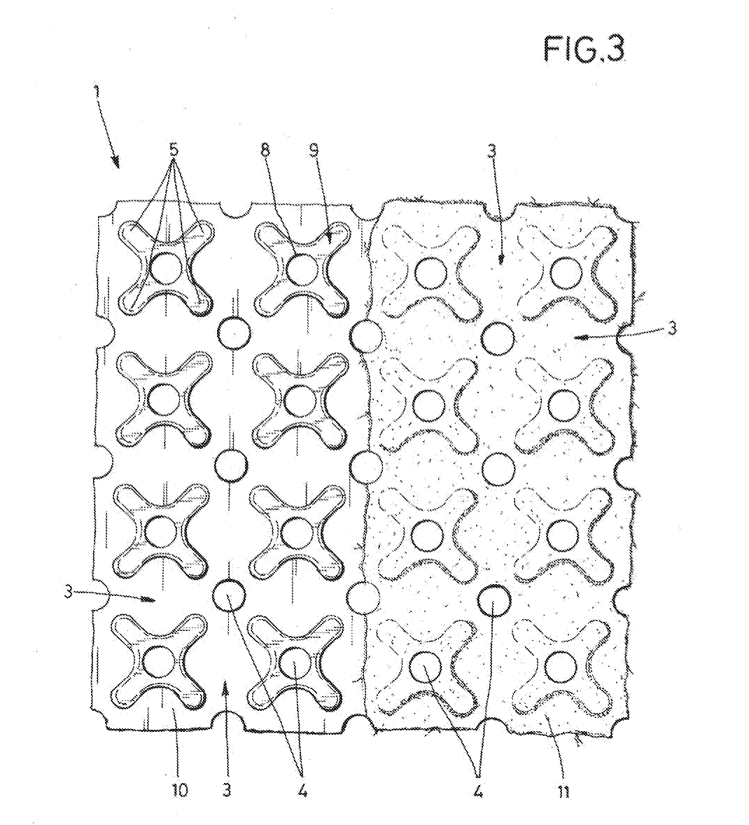

FIG. 3 illustrates an embodiment in which the four smaller raised profiles 5, which are individually formed in the embodiments shown in FIGS. 1 and 2 and define the four corners of a square, are connected to each other to form a cross-or X-shaped raised area 9. These cross- or X-shaped raised areas 9 are also arranged in a square grid, so that, with this embodiment, too, troughs or channels 3 are formed between the raised areas 9, these channels 3 running in straight lines and intersecting each other.

Through-holes 4 may also be provided in the embodiments shown in FIGS. 2 and 3, for example, as central through-holes 4, always in the center of a nub group or of a cross-shaped raised area 9, as well as, for example, as cross-shaped through-holes 4 that are always placed where two channels 3 intersect. Thus, the X-shaped raised areas 9 in the embodiment shown in FIG. 3 connect not only the four smaller raised profiles 5, but they also integrally form the raised profiles 8 around the central through-holes 4, which, in the embodiments of FIGS. 1 and 2, are constructed as separate rings.

FIG. 4 illustrates a vertical cross-section through the retaining surface 1 according to the invention, whereby the cut runs through two raised areas 9, as well as through the intersection of two channels and, thus, through the corresponding through-hole 4. The retaining surface 1 in this area of the vertical cross-section consists of only two elements: the carrier 10, which is a three-dimensionally shaped thermoforming film and has a relief structure with raised areas 9 that define adjacent relief areas 10A. The structural surface 11 that is laminated to the carrier 10 is constructed as the fleece portion of a touch hook-and-loop fastener and has many loops. The structural surface 11 is pressed into the heated material of the carrier 10 as a way of directly laminating it to the carrier 10, so that a firm bond is made between the carrier 10 and the structural surface 11, without the use of additional materials, such as adhesive. Due to the wavy relief structure of the structural surface 11 and/or the use of a press-on tool having a profile, for example, a roller with a profile, only the relief sections 12, i.e., valleys, of the structural surface 11 are bonded to the carrier 10.

During the lamination process, the structural surface 11 is pressed onto the raised areas 9 of the relief structure of the carrier 10. The material of the structural surface 11 is suspended freely between the raised areas 9, possibly without making contact with the carrier. A highly profiled pressure pad may be used, for example, a profiled roller, to simplify the stamping process and ensure a precise stamping result when stamping out the through-holes 4 at the intersections of channels 3. Such a tool is able to press the structural surface 11 into even these deeper lying intersection areas on the carrier 10. As a result, the structural surface 11 may be laminated onto the carrier 10, even in these relief areas 10A of the carrier 10.

Independently of the relief structure of the carrier 10 shown in the FIGS. 1 to 4, the structural surface 11 itself has a relief structure or depth, so that the structural surface 11 imparts a particularly secure hold on the tube 6 that is pressed onto the retaining surface 1 or to other objects, even when a carrier 10 is used that is flat and does not have its own relief structure.

It is understood that the embodiments described herein are merely illustrative of the present invention. Variations in the construction of the retainer panel with a three-dimensional structural surface may be contemplated by one skilled in the art without limiting the intended scope of the invention herein disclosed and as defined by the following claims.

What is claimed is:

1: A retainer panel comprising:
a carrier that is formed from a three-dimensionally contoured thermoforming film that provides a relief structure having raised areas and relief areas; and
a structural surface made of a material that has a microscopic roughness and that is affixed to the carrier by direct lamination;
wherein the structural surface forms one component of two components of a touch fastener;
wherein the structural surface is placed on the carrier with an excess of the material and attached to the carrier, such, that the structural surface has a wavy contour with peaks and valleys on at least a face of the structural surface that faces away from the carrier, the wavy contour providing a macroscopic roughness of the structural surface;
wherein only the valleys of the wavy contour of the structural surface are laminated to the carrier;
wherein the direct lamination of the structural surface to the carrier creates directly laminated areas of the structural surface and the carrier and other unlaminated areas in which the structural surface is loosely placed on the carrier; and
wherein the directly laminated areas are arranged to provide a layout grid.

2: The retainer panel of claim 1, further comprising a plurality of through-holes.

3: The retainer panel of claim 1, wherein the raised areas of the relief structure are arranged to form a plurality of channels, any two adjacent areas of the raised areas forming a channel;
wherein a section of a circumference of a tube is receivable in the channel; and
wherein the plurality of channels includes a first plurality of channels that run parallel to each other and a second plurality of channels that run parallel to each other, the first plurality of channels intersecting the second plurality of channels.

4: The retainer panel of claim 3, wherein the any two raised areas that form a channel are spaced a first distance apart and any two parallel channels are spaced a second distance apart, the second distance being greater than the first distance.

5: The retainer panel of claim 3, wherein the first plurality of channels intersects the second plurality of channels so as to form a square grid pattern.

6: The retainer panel of claim 3, wherein raised profiles are provided in areas between the intersecting channels and are spaced apart, such, that a free space is formed the raised profiles, and wherein a section of a tube having a curved run is placeable in the free space between the raised profiles.

7: The retainer panel of claim 1, wherein the retainer panel has a four edges and wherein an overlap strip is provided under the carrier on at least one of the four edges and that is connectable with an adjacent retainer panel.

8: The retainer panel of claim 7, wherein the adjacent retainer panel is self-adhesive, thereby enabling an adhesive connection with the overlap strip.

9: The retainer panel of claim 1, wherein the carrier is self-adhesive on a surface that faces away from the structural surface.

10: The retainer panel of claim 9, wherein the carrier is self-adhesive beyond an area of the overlap strip.

11: The retainer panel of claim 1, wherein the touch fastener is a touch hook-and-loop fastener and wherein the structural surface is a two-dimensional textile that has a plurality of loops and that serves as a loop component of the touch hook-and-loop fastener.
